(19) United States
(12) Patent Application Publication
(10) Pub. No.: US 2019/0145055 A1
(43) Pub. Date: May 16, 2019

(54) INFILL MATERIAL FOR ARTIFICIAL GRASS SURFACES, AN ARTIFICIAL GRASS SURFACE STRUCTURE AND A RECYCLING METHOD

(71) Applicant: POLYGREEN SRL, DESENZANO DEL GARDA (IT)

(72) Inventors: Massimo BARALDI, Sirmione (IT); Roberto DIAN, Sirmione (IT); Riccardo MARITANO, Sirmione (IT)

(73) Assignee: POLYGREEN SRL, Desenzano Del Garda (IT)

(21) Appl. No.: 16/098,063

(22) PCT Filed: May 2, 2017
(86) PCT No.: PCT/IB2017/052531

§ 371 Date: Oct. 31, 2018

(30) Foreign Application Priority Data
May 5, 2016 (IT) 102016000046445

(51) Int. Cl. E01C 13/08; B29B 17/04

(52) U.S. Cl. CPC E01C 13/08; B29B 17/0412

(57) ABSTRACT

An artificial grass surface structure (1) for sports fields includes a mat (2) with filaments (4) which simulate a grass surface, and at least a filling layer (5) having a granular infill material (6) arranged between the filaments (4). The granular infill material for synthetic grass surfaces includes a plurality of granules (8) having a thermoplastic polymeric matrix and a load dispersed in the matrix. The load includes at least a cellulose-based vegetable component.

The present invention relates to the sector of artificial grass surfaces, in particular for realising sports fields. In particular, the present invention relates to an infill material to be used for filling artificial grass surfaces, and the relative artificial grass surface structure.

Artificial grass surfaces are generally constituted by a mat formed of filaments of polymeric material, which simulate a grassy lawn, and one or more filling materials, in granular, dispersed in the mat.

Filling materials, as is known, use silica sand or prevalently elastic materials, such as natural rubber, synthetic or vulcanised rubber, for example originating from recycling of tyres, or materials of vegetable origin, such as tree fibre, coconut fibre, coco peat or cork, or materials having a thermoplastic origin, such as vinyl polymers, SBS, SEBS, polyurethane, polyethylene and the like.

Filling or infill materials are typically subdivided into two categories:
stabilising infill, commonly silica sands, which serve to give stability to the mat, ballasting the surface; these infills are commonly spread as a first filling layer.
performance infill, in general materials of polymeric or vegetable origin, which serve to give the mat excellent characteristics for sport, such as shock absorption, bounce, ball-rolling, comfort; these infills are commonly spread following the stabilising infill, in one or more superposed layers.

The granules formed by materials of thermoplastic origin are generally constituted by a polymeric matrix with additives of mineral loads, such as calcium carbonate or talcum, for reducing the quantity of polymer (and therefore the price), as well as for giving some technical characteristics.

The granules are typically realised by extrusion and cutting; the cutting is done following the output in fluid form of the material through an die, a shape of which determines the dimension and form of the granule.

The granules are all of an identical size and notwithstanding the existence of granules of different shapes in the sector (egg-shaped, bean-shaped, cylinder-shaped, star-shaped, hollow tube-shaped, three-lobed, etc), all the shapes have been demonstrated to have a poor performance in terms of volume.

Further, the various forms of the granules have demonstrated respective drawbacks: for example, the egg and cylinder shapes showed poor stability inside the mat (with consequent translations and movement of the infill during rainfall); the tube shapes demonstrated poor resistance to treading with consequent crushing and a change of dimension.

Granules are also known which are formed by a polymeric matrix in which, instead of mineral loads, loads of vegetable origin, as illustrated, for example in document WO 2008/053389 or document WO 92/19669.

These granules too, however, have demonstrated some drawbacks, such as the poor availability of the raw material, or the difficulty of the production process, given the possibility of burning the vegetable component during the hot-extrusion.

There exists, therefore, a need for researching new granular infill materials, as the materials known today are not entirely satisfactory in terms of, for example, performance, volumetric performance, maintenance of moisture on the surface, costs, drainage capacity, degrading over time and environmental impact.

The aim of the present invention is to provide a granular infill material for artificial grass surfaces which satisfies the needs of the sector and obviates the drawbacks that have been mentioned with reference to the prior art.

The technical task is attained by a granular infill material in accordance with claim 1. The dependent claims relate to further embodiments of the invention.

The characteristics and the advantages of the granular infill material according to present invention will emerge from the following description, given by way of non-limiting example, according to the appended table of drawings, in which

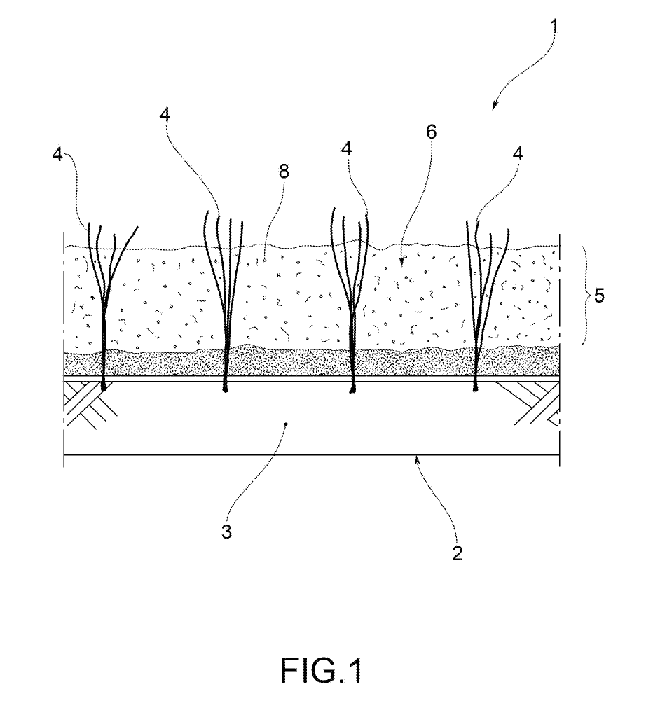

FIG. 1 is a diagram of a grass surface with artificial grass containing a granular filling material according to the present invention.

With reference to FIG. 1, reference numeral 1 denotes in its entirety an artificial grass surface structure, in particular for sports fields.

The structure 1 comprises a mat 2 having a substrate 3 from which filaments 4 rise to simulate a grass surface.

The structure 1 further comprises a filling layer 5 formed by a granular infill material 6 arranged among the projecting filaments.

The granular material 6 is constituted by a mixture of granules 8, formed by a thermoplastic polymeric matrix and by a load dispersed in the matrix. The load includes at least a cellulose-based vegetable component. The vegetable load is preferably cellulose.

The cellulose is preferably present in a measure of between 20%-40% in weight, minimum and maximum included, preferably between 20%-30%, minimum and maximum included.

Said granules preferably originate from offcuts and waste of wallpaper or another cellulose-based material. Wallpaper is in fact constituted by a paper support on which a polymeric material is spread.

Further, the thermoplastic polymeric material of the matrix is preferably selected from among a group comprising vinyl resins, for example polyvinyl chloride (PVC), polyurethane, polyester, polypropylene.

The granular material according to the invention has an appreciable granular porosity; the porosity enables obtaining a water absorption that is particularly appreciated; the water absorption is preferably comprised between 10% and 60%, and is preferably 30%.

The water absorption is measured using a dedicated measuring method, which includes:
immersion in a water-filled container—of 1 kg of granular material (initially kept submerged, so that it is thoroughly soaked), for a predefined time, in general 10 minutes;
collecting the soaked granular material from the container, dripping the material on a perforated grid (typically with holes of 1 mm diameter), for a predefined time, generally up to the end of the dripping and for a minimum of 20 minutes;
weighing the soaked and dripped material;
calculating the water absorption in percentage form from the ratio with the dry weight of the granular material.

The granular material described in the foregoing can be obtained by a working process of the type described in Italian patent n. 10 2015 0000 2085 5, appropriately modified, the teachings of which are expressly incorporated herein.

In a preferred embodiment, the granular material and the artificial grass surface structure according to an embodiment of the present invention can be recycled.

The recycling method includes using, as performance infill, a granular material with a vegetable load based on cellulose, or cellulose, with added mineral loads and further vegetable components.

The method further includes a cutting step of the clump structure, ground and newly-re-forged, so as to newly obtain a material of an identical nature as that previously removed.

Said recycling method can be advantageously carried out in situ.

The granular material of the invention innovatively obviates the drawbacks of the prior art and meets the needs of the sector.

In fact, the granule of the invention generally has an irregular prismatic shape with a high apparent density, due to the vegetable component; this leads to excellent filling of the spaces, because of the shape of the granule, and a volumetric performance that is better than that of the traditional polymeric materials.

Further, the granule of the present invention has a high degree of porosity, able to retain rainwater, which restores freshness to the surface during dry days.

Further, the cost is advantageously very modest, as cellulose is abundant and easy to source, even where it does not originate from the recycling of wallpaper, but is added as a raw material to the polymeric material.

Further, and advantageously, by varying the quantity of cellulose present in the granule, it is possible to obtain infill material with various characteristics, for example more or less rigid, more or less hygroscopic or with a greater or lower apparent density.

Obviously, a technical expert in the sector, with the aim of satisfying contingent requirements, might make modifications to the granular material described in the foregoing, all of which fall within the scope of protection as defined in the claims that follow.

1. A granular infill material for artificial grass surfaces, comprising a plurality of granules comprising a thermoplastic polymeric matrix and a load dispersed in the matrix, wherein the load includes at least a cellulose-based vegetable component.

2. The material according to claim 1, wherein the load is cellulose.

3. The material according to claim 1, wherein the thermoplastic polymeric matrix comprises at least a material selected from the group consisting of vinyl resins, polyvinyl chloride, polyurethane, polyester, polypropylene.

4. The material according to claim 1, wherein the granules derive from a processing of wallpaper.

5. The material according to claim 1 having a water absorption of between 10% and 60%.

6. The material according to claim 1, wherein the granule further has mineral loads or further vegetable components added.

7. The material according to claim 1, wherein the cellulose is present in a measure of between 20%-40% by weight, minimum and maximum included.

8. An artificial grass surface structure for sports fields, comprising a mat with filaments which simulate a grass surface, and at least a filling layer comprising a granular infill material according to claim 1, arranged between the filaments.

9. An artificial grass surface structure (1), in particular for sports fields, comprising a mat with filaments simulating a grass surface, at least a filling layer for stabilising positioned inferiorly and at least a performance filling layer comprising a granular infill material arranged between the filaments, wherein the granular infill material comprises a plurality of granules comprising a thermoplastic polymeric matrix and a load dispersed in the matrix, comprising cellulose, arranged superiorly.

10. A recycling method comprising steps of:
providing an artificial grass surface structure comprising a mat with filaments simulating a grass surface, and at least a performance filling layer comprising a granular infill material according to claim 6, arranged among the filaments;
cutting the structure into clumps;
grinding the clumps to obtain a ground material;
re-forging the ground material for obtaining said granular infill material according to claim 6.

11. The material according to claim 1, the material having a water absorption of about 30%.

12. The material according to claim 1, wherein the cellulose is present in a measure of between 20%-30% by weight, minimum and maximum included.
